(19) United States
(12) Patent Application Publication
(10) Pub. No.: US 2023/0014079 A1
(43) Pub. Date: Jan. 19, 2023

(54) METHOD AND APPARATUS FOR DEVICE TO DEVICE COMMUNICATION FOR CELLULAR DEVICES

(71) Applicant: SIERRA WIRELESS, INC., Richmond (CA)

(72) Inventors: Gustav Gerald VOS, Surrey (CA); Vishnu RAJENDRAN CHANDRIKA, Vancouver (CA); Gautham PRASAD, Vancouver (CA); Lutz Hans-Joachim LAMPE, Vancouver (CA)

(73) Assignee: SIERRA WIRELESS, INC., Richmond, BC (CA)

(21) Appl. No.: 17/756,902

(22) PCT Filed: Nov. 27, 2020
(86) PCT No.: PCT/CA2020/051632

§ 371 Date: Jun. 3, 2022

Related U.S. Application Data
(60) Provisional application No. 62/944,866, filed on Dec. 6, 2019.

(51) Int. Cl. H04W 76/28; H04W 76/30

(52) U.S. Cl. CPC H04W 76/28; H04W 76/30; H04W 92/18

(57) ABSTRACT

There is provided a method and user equipment for a user equipment (UE) to perform device to device communication, for example sidelink communication. The method includes identifying, by a user equipment (UE), a time opportunity for the sidelink communication. The method further includes upon determination of a need for the sidelink communication, activating, by the UE, the sidelink communication during the time opportunity. In some embodiments, the method further includes the UE transmitting a sidelink availability message. In some embodiments, the time opportunity is at least in part dependent on the mode of operation of the UE.

### CROSS REFERENCE TO RELATED APPLICATIONS

This application claims the benefit and priority of U.S. Provisional Patent Application 62/944,866 titled “Method and Apparatus for Sidelink Communication on Unlicensed Bands for Cellular Devices” filed Dec. 6, 2019. The foregoing application is incorporated by reference herein in its entirety.

### FIELD OF THE INVENTION

The present invention pertains to the field of telecommunications and in particular to methods and apparatuses for device to device communication, for example sidelink communication, for devices including LTE, NB-IoT and 5G(NR) devices.

### BACKGROUND

Currently, legacy cellular UEs (user equipment) communicate with each other via a base station (BS) irrespective of how close they are to each other. This procedure typically involves using licensed resources that incurs additional costs and consumes extra time and power to establish connections over the cellular network. Device to device (D2D) communications, for example sidelink (SL) communication, on the other hand, enables UEs to directly communicate with each other sometimes with and sometimes without assistance from the BS. This communication may potentially improve network latency and battery life of the UE. Further using the unlicensed band for SL (SL-U) provides these benefits without requiring additional licensing and service provider subscription costs.

While there are protocols that already exist for SL-U, such as Bluetooth™ and ZigBee™, a major drawback in directly using these protocols for SL-U is that they do not allow the integration of SL-U within conventional cellular devices or require a 2^{nd} radiofrequency (RF) chain. Furthermore, there are a few additional roadblocks to adopting these protocols for SL-U on cellular devices. For example, Bluetooth™ is not defined for the 863-870 MHz license free band in Europe (SRD860) or the 902-928 MHz unlicensed frequency spectrum in the USA. The (SRD860) regulatory requirements impose frequency and duty cycle limits that would prevent implementation of a Bluetooth™ like protocol. In addition, Bluetooth™ uses a master-slave topology that increases network latency when two slave UEs want to communicate with each other directly. Furthermore, ZigBee™ recommends the usage of carrier-sense multiple access with collision avoidance (CSMA/CA) that may further increase network latency. It is noted that neither of these protocols have the flexibility of adapting the operation to different performance constraints, such as a customized latency or customized power-saving.

Additionally, integrating SL on Category-M1 cellular devices imposes an added constraint to the function of devices that are designed for half-duplex (HD) and frequency division duplexing (FDD) operation.

Accordingly, there may be a need for methods and apparatuses for device to device communication, for example sidelink communication, for devices including LTE, NB-IoT and 5G(NR) devices, that is not subject to one or more limitations of the prior art.

This background information is intended to provide information that may be of possible relevance to the present invention. No admission is necessarily intended, nor should be construed, that any of the preceding information constitutes prior art against the present invention.

### SUMMARY

It is an object of the present invention to obviate or mitigate at least one disadvantage of the prior art.

According to an aspect of the present invention, there is provided a method for device to device communication, for example sidelink communication between devices including LTE, NB-IoT and 5G(NR) devices.

According to an aspect of the present invention, there is provided a method for a sidelink communication. The method includes identifying, by a user equipment (UE), a time opportunity for the sidelink communication. The method further includes upon determination of a need for the sidelink communication, activating, by the UE, sidelink communication during the time opportunity.

In some embodiments, the method further includes the UE transmitting a sidelink availability message.

In some embodiments, the time opportunity is at least in part dependent on a mode of operation of the UE. In some embodiments, when the UE is in ConA mode, the time opportunity is at least in part dependent on transmit time intervals (TTIs) when receiving and transmitting cellular communications is unexpected by the UE. In some embodiments, when the UE is in DDRX mode, the time opportunity is at least in part dependent on when the UE is in the ON period. In some embodiments, when the UE is in FDRX mode, the time opportunity is at least in part dependent on when the UE wakes up during a FDRX cycle.

In some embodiments, identifying a time opportunity for the sidelink communication is performed periodically. In some embodiments, the time opportunity is equivalent to one subframe. In some embodiments, the time opportunity is equivalent to multiple subframes.

According to another aspect of the present invention there is provided a UE including a processor and a non-transient memory for storing instructions. The instructions, when executed by the processor cause the UE to be configured to identify a time opportunity for the sidelink communication and upon determination of a need for the sidelink communication, activate the sidelink communication during the time opportunity.

In some embodiments, the instructions, when executed by the processor further cause the UE to be configured to transmit a sidelink availability message.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A illustrates cellular communications mode transitions.

FIG. 1B illustrates cellular communications state transitions in LTE-M.

FIG. 2 illustrates a method for sidelink communication, in accordance with embodiments.

FIG. 3 illustrates examples for free subframes (SF) when there is no UL/DL, according to embodiments.

FIG. 4 illustrates a sidelink paging occasion in cellular communication DDRX, according to embodiments.

FIG. 5 illustrates a sidelink paging occasion in cellular communication CDRX on an LTE-M UE, according to embodiments.

FIG. 6 illustrates an example of interleaved SL-PO, according to embodiments.

FIG. 7 illustrates an example of consecutive SL-PO, according to embodiments.

FIG. 8 illustrates an example where a UE is continuously listening in CC FDRX mode when the UE is in low latency mode, according to embodiments.

FIG. 9 illustrates a SL SF pattern for 4 HARQ processes, according to embodiments.

FIG. 10 illustrates a timing diagram for grant free HARQ, according to embodiments.

FIG. 11 illustrates a timing diagram for grant based HARQ according to embodiments.

FIG. 12 illustrates an example of SAM-U transmission when DST UE is in ConA mode, according to embodiments.

FIG. 13 illustrates an example of SAM-D transmission when DST UE is in CC DDRX mode, according to embodiments.

FIG. 14 illustrates an example of continuous SL listening in LLM during CC DDRX mode, according to embodiments.

FIG. 15 illustrates an example of SAM transmission when DST UE enters FDRX mode in RAI, according to embodiments.

FIG. 16 is a schematic diagram of an electronic device according to embodiments.

### DETAILED DESCRIPTION

A high-level problem definition can be envisioned as defining design protocol changes on top of LTE SL and New Radio (NR) SL to support D2D communication between wireless devices. This communication may be on licensed or unlicensed bands and may coexist and operate concurrently with legacy cellular operation. Specifically, the protocol should provide for several features which may include one or more of: requiring only a single radio to provide concurrent D2D and cellular service, operating on HD-FDD devices, conforming to regulatory requirements of unlicensed spectrum (for example in the European and North American unlicensed bands of 863 to 870 MHz and 902 to 928 MHz, respectively) and providing flexible latency and battery life configurations.

It will be readily understood that communication between wireless devices can be enabled in multiple ways, and it can be defined as device to device (D2D) communications. In some embodiments of the present disclosure D2D communication has been defined as sidelink (SL) communications as an example. However, it will be readily understood by a worker skilled in the art how to apply any embodiments which may be defined as SL communications to a more general version of D2D communications. It will be further understood that while some of the discussion below relates to D2D communications, for example SL communications, using unlicensed bands, it would be readily understood how to apply such embodiments when using licensed bands as well.

According to embodiments, there is provided methods and apparatus for accommodating both D2D communications, for example sidelink (SL) communication together with cellular communication on a wireless device. According to some embodiments there is provided guidance for accommodating concurrent D2D or SL or SL-U and cellular communications with a single half duplex radio. A solution for accommodating concurrent D2D or SL or SL-U communications and cellular communications with single half duplex radio is to operate D2D or SL or SL-U as a secondary RAT (radio access technology) where the cellular communications (CC) RAT is the primary RAT. Therefore, D2D or SL or SL-U communications is performed only when the UE is not used for CC. Possible instances where a UE is free for D2D or SL or SL-U communications are provided below. The time instances available for D2D or SL or SL-U depends on the CC mode. For CC, UEs are generally in one of three modes, namely connected active (ConA) mode, dynamic discontinuous reception (DDRX) mode or fixed discontinuous reception (FDRX) mode.

In ConA mode, the UE regularly communicates with the base station through uplink (UL) and downlink (DL) messages that are partitioned in transmission time intervals (TTIs), which are often 1 sub-frame or 1 ms in length. The UE exits ConA mode after a period of inactivity to enter a power-saving dynamic discontinuous reception mode (DDRX). For example, in LTE-M, this inactivity time is referred to as DRX inactivity time tracked by a DRX inactivity timer (DRX IT) and the state is referred to as connected mode DRX (CDRX). However, the UE may also enter a fixed DRX (FDRX) mode after a period of inactivity. In LTE this is the Idle mode DRX (IDRX). In some configurations, in for example LTE-M and NB-IoT this can occur more quickly if the release assistance indication (RAI) feature is used.

DDRX mode is where the sleep periods and ON periods are dynamically assigned by the base station at the start of the connections and where the ON Period is typically multiple TTIs and the sleep period is short (e.g. <1 second). The UE exits the DDRX mode after a period of inactivity to enter the FDRX mode. For example, in LTE-M, the ON Period is called the DRX-ON period and can either occur as soon as the UE enters the connected discontinuous reception (CDRX) state or after an offset duration, and the inactivity period is referred to as data inactivity time tracked by the Data Inactivity Timer (Data IT).

FDRX is where the sleep periods and ON Period are fixed and specified based on a UE identifier (UEID)-dependent equation which is predefined, where the ON Period is typically 1 TTI and the sleep periods are longer (e.g. multiple seconds). Some examples of FDRX mode are the I-DRX state and the Inactive state in LTE and NR.

If the UE receives a valid page during its ON period in the FDRX mode, the UE transitions into the ConA mode through a radio resource control (RRC) connection setup procedure. Throughout the entire DDRX and FDRX modes, the UE has the ability to transition back into the ConA mode anytime it has UL data to transmit.

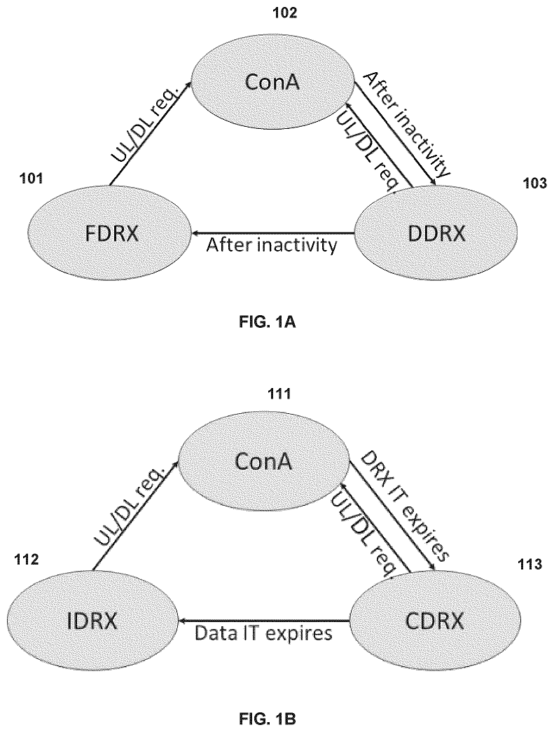

FIG. 1A illustrates cellular communication mode transitions between FDRX 101, ConA 102 and DDRX 103. FIG. 1B illustrates cellular communication state transitions in LTE-M, for example ConA 111, IDRX 112 and CDRX 113.

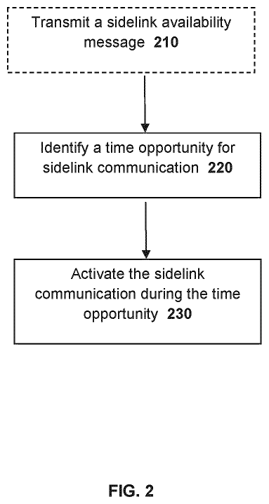

According to embodiments there is provided a method and apparatus for user equipment (UE) to perform D2D, for example sidelink communication. According to some embodiments there is provided a method and apparatus for user equipment (UE) to perform sidelink communication. With reference to FIG. 2, the method includes identifying 220, by a user equipment (UE), a time opportunity for the sidelink communication. The method further includes upon determination of a need for the sidelink communication, activating 230, by the UE, sidelink communication during the time opportunity. In some embodiments, the method further includes the UE transmitting 210 a sidelink availability message.

According to embodiments, there are time opportunities available to perform D2D or sidelink communication, for example SL or SL-U communications, in each of the above-mentioned UE modes, namely ConA, DDRX and FDRX.

In ConA there may be periods of time for D2D or SL or SL-U communications during the TTI provided for switching the radio of the UE between transmission and reception. For example, for HD-FDD and time division duplex (TDD), between every uplink (UL) and downlink (DL) operation, the UE is allotted a time slot (e.g. one subframe (SF) for LTE-M) for switching its radio from UL→DL and DL→UL. However, some radios only require a fraction of this time provided, so for these types of radios the remainder of the TTI can be used for D2D or SL or SL-U communications.

In ConA there may be one or more TTIs where no data is needed to be transmitted. For example, if the UE does not have full DL and UL buffers, there would be some unused TTIs that can be used for D2D or SL or SL-U communication. For example, for TDD, the time slots designated for UL can be used if there is no UL traffic, and similar with the DL. For HD-FDD, the UL and DL slots are not predefined but are dynamic based on traffic, but empty TTIs can also occur. One example for HD-FDD is shown in FIG. 3, where such a free SF is available when there is no grant sent for a SF because the UL buffer is empty. It is noted that in FIG. 3, “G1, G2, G3, G4, G5” represent grants 302, “S” represents switch 304 between transmission and reception, “U1, U2, U3, U4, U5” represents uplink 306 and “A1, A2, A3” represents acknowledgment 308.

In addition, in ConA decoding may be faster thus not requiring the allotted time therefor. For example, often CC protocols specify minimum times between grants and data and minimum times between the data and the acknowledgment (ACK). If a UE can decode grants and data faster than the specified times, those TTIs can be used for D2D or SL or SL-U communications. For example, for narrow band internet of things (NB-IOT) UE, the minimum gap between grants=>data is 4 SF, and data=>ack is 12 SF so if a UE can decode faster than specified, the UE can then use the SF for D2D or SL or SL-U.

In ConA, there can be a situation where there can be multi-RAT coexistence. For example, the UE may request times from the CC base station where it will not be available for CC reception or transmission and use those TTI for D2D or SL or SL-U communications. This could be in the form of a bit mask where a 1 in the bit mask indicates where the TTI is not available for CC reception or transmission. An already existing mechanism for another RAT may also be used (e.g. WiFi). For example, in LTE there is an InDeviceCoexIndication mechanism, which is primarily defined for WiFi coexistence, however this can also be used for D2D or SL or SL-U communications. It is also planned for 3GPP Rel. 17 to allow a UE to have more than one SIM and to be actively connected simultaneously to more than one corresponding cellular network using a similar indication.

According to embodiments, the UE is capable of performing D2D or SL or SL-U communications during a time opportunity. A time opportunity can be defined as a period in time when a UE is capable of performing D2D communications, namely a period of time wherein the UE is not performing actions involved with cellular communication. A time opportunity can be dependent on the mode in which the UE is operating, for example ConA mode, DDRX mode or FDRX mode, or other mode as would be readily understood.

In ConA mode there can be a situation where the base station has and thus is operating using a map of Invalid TTIs. For example, the base station may also define TTIs where it will not expect the UE to receive or transmit CC and those TTIs can then be used for D2D or SL or SL-U communications, namely time opportunities for D2D, SL or SL-U communications. For example, in NB-IOT and LTE-M, the eNB sends a dd-DownlinkOrTddSubframeBitmapBR to indicate which SFs are valid.

In DDRX mode a UE is in either an ON state or an OFF state, with the ON period being the only time duration when the UE is busy with the CC link. All other times can be used for D2D or SL or SL-U communications when the UE is in DDRX mode, namely time opportunities for D2D or SL or SL-U communications.

In FDRX mode, in order to support CC paging, the UE wakes up every FDRX cycle to decode the paging channel, and thus all other times are available for D2D or SL or SL-U communications when the UE is in FDRX mode, namely time opportunities for D2D, SL or SL-U communications.

However, it has been considered that continuously listening for D2D or SL or SL-U communications when the UE is free from a CC link, drains the battery when there is no D2D or SL or SL-U communications traffic.

According to embodiments, to address this issue, the sidelink discontinuous reception (SL-DRX) is introduced, where the UE only wakes up periodically (i.e. once every SL-DRX period). Since the acceptable mobile terminated (MT) latency is different for different applications, the SL-DRX period can be chosen by the UE so that the application can trade-off power and MT latency. The UE which may wish to perform D2D or SL or SL-U communications will register their SL-DRX period choice with a central server (i.e. the SL Server). A SRC (source) UE (i.e. a UE that wants to transmit SL to a DST (destination) UE) will request the DST UE's SL-DRX period from the SL server before it attempts to send data to it. The SL-DRX may have a TTL (time to live) associated with it so that the SRC UE doesn't have to request the SL-DRX period for each D2D or SL or SL-U transaction, for example, for each transmission.

When in cellular coverage, the UEs which may wish to perform D2D or SL or SL-U communications can use the cellular network to be synchronized. For LTE, this is the primary synchronization signals/secondary synchronization signals (PSS/SSS) and master information block (MIB). This can ensure that the DST UE is listening when the SRC UE is transmitting. According to embodiments, the DST UE can be capable of handling a certain amount of timing error to account for base station synchronization errors (i.e. the timing error between base stations) and timing errors due to the transmission time. For the out of coverage scenario (where both UEs are out of coverage) or partial coverage scenario (where one UE is in coverage and one UE is out of coverage), the legacy LTE SL or NR SL synchronization signals and procedures can apply. When not in cellular coverage the D2D or SL or SL-U UEs could use GPS timing, if they can receive GPS.

According to embodiments, the SL paging opportunity (SL-PO) (i.e. the TTI(s) where the DST UE listens for D2D or SL communications each SL-DRX cycle) can be calculated to ensure the SL-PO does not overlap with the CC FDRX PO. The SL-PO is computed based on an equation using the UE-ID (e.g. IMEI) and the SL DRX period, which are obtained from the central SL server. No overlap between deterministic FDRX PO in the CC link and SL-PO can be ensured by the SL-PO computation equation by introducing a TTI offset between the CC POs and SL-POs. This offset can be fixed or provided by the SL server.

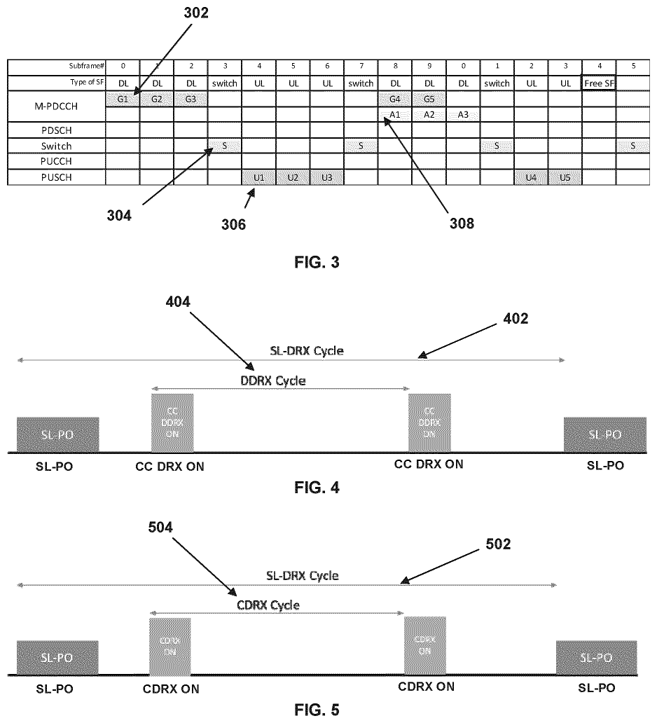

According to embodiments, the SL-DRX period does not have to be the same as the DDRX or FDRX period. However, having the SL-DRX period as a multiple ensures that the ON periods do not overlap (i.e. slide across each other). FIG. 4 illustrates an example of a condition where the SL-DRX 402 cycle is twice the DDRX 404 cycle, according to embodiments. FIG. 5 illustrates the same operation when using SL-U on an LTE-M device, where the SL-DRX 502 cycle is twice the CDRX 504 cycle, according to embodiments. It would be readily understood that this operation could equally be used for D2D or SL communications.

According to embodiments, there is provided a method for supporting efficient transmission of D2D or SL or SL-U messages of different lengths. According to embodiments, the SL-PO can operate in multiple ways and can be characterized by UEs using X separate SL-POs of length Y whose beginning TTIs are spaced Z TTIs apart. It is noted that for this configuration, Z≥Y. For larger D2D or SL or SL-U messages, a larger value of X is considered to be preferred since multiple transport blocks can be sent quickly. However, for better battery life of the UE, a smaller value of X is preferred. Larger values of Y provide reliability to errors but have a detrimental impact on battery life. Larger values of Z provide time diversity but also have a detrimental impact on battery life. Based on the characteristics of the SL-PO, they can broadly be classified into two categories, namely interleaved and consecutive.

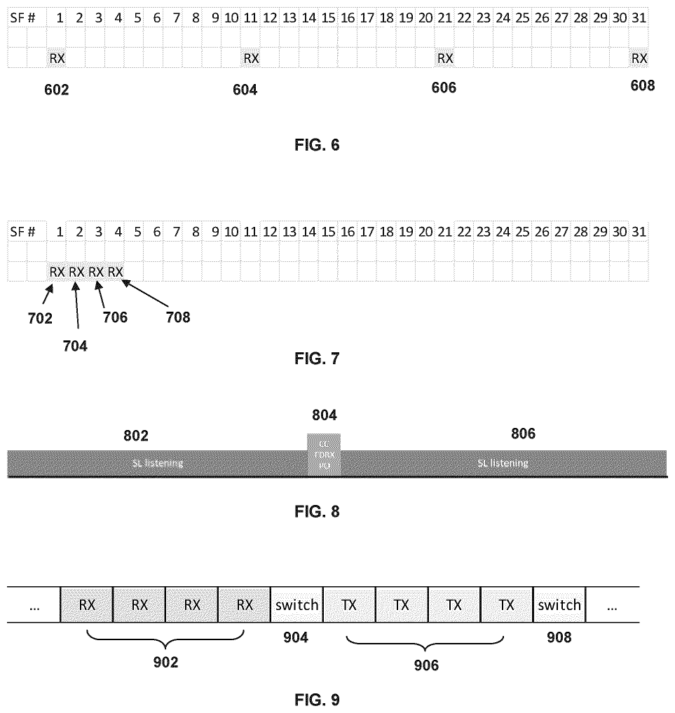

According to embodiments, interleaved SL-PO can be defined wherein Z>Y, and therefore, there are gaps in between consecutive SL-PO instances. This configuration can support a quick transmission of an SL-U message of length Y. It would be readily understood that this SL-U message could equally be used for D2D or SL message. FIG. 6 shows an example with X=4, Y=1, and Z=10, wherein the receiver is operational during SF 1 602, SF 11 604, SF 21 606 and SF 31 608. According to embodiments, consecutive SL-PO can be defined wherein Z=Y, wherein the receiver is operational during SF 1 702, SF 2 704, SF 3 706 and SF 4 708. FIG. 7 shows an example where X=4, Y=1, Z=1, wherein this condition is suitable for longer D2D or SL or SL-U messages.

According to embodiments, there is provided a method for supporting latency critical D2D or SL or SL-U applications. When latency is critical and/or UEs are not restricted by battery life (for example a smart meter that is connected to a power source or grid) the SL-DRX period can be set to zero. When SL-DRX period=0 it is considered to be in SL LLM (low latency mode) where the UE does not go to sleep at any time and continually listens to SL whenever it does not have cellular demands or does not transmit SL. This scenario is illustrated in FIG. 8, showing the cellular demand on the UE during the CC FDRX PO 804 time period and the UE is listening for sidelink communications during 802 and 806 time periods.

According to embodiments, SL-DRX will increase control plane latency (a one time latency to start a connection) which can be acceptable. However, once a D2D or SL transmission occurs the UE often needs lower latency (for example user plane latency) to support interactive messaging (for example TCP).

According to embodiments, a variable length SL connected mode is introduced to accommodate interactive SL communications between two UEs.

SL connected mode is the mode in which two SL UEs have regular communications and operate in a TDD like manner where they are either listening for D2D or SL or SL-U communications or have the opportunity to transmit D2D or SL or SL-U communications with a RX-TX switching slot in between.

According to embodiments, a SRC UE enters the SL connected mode after it sends a D2D or SL or SL-U message, wherein the message would depend on the format or band being used for the communications. A DST UE enters SL connected mode after it receives a valid D2D or SL or SL-U message. Once the UE enters the SL connected mode, the UE supports multiple parallel HARQ processes (for example, 4 or 8 HARQ processes, as commonly used in LTE) where the UE uses consecutive SFs for TX followed by a guard period for switching (e.g. 1 SF), and then consecutive RX followed by another possible guard period (i.e. in a TDD like manner). The pattern of switching is based on the number of HARQ processes supported. An example is illustrated in FIG. 9 where 4 parallel HARQ processes are supported. For example, there are 4 SFs 902 used for receiving and subsequent switch subframe 904 wherein the UE switches from reception to transmission subsequently followed by 4 SFs 906 for transmission and then a switch subframe 908.

According to embodiments, the pattern can be fixed, namely predefined, or can be UE specific and stored in the SL Server where the SRC UE follows the pattern set by the DST UE. The UEs monitor the SL for any possible transmission or retransmission until an SL inactivity timer expires. Upon expiry, the UE implicitly releases the SL connection.

According to embodiments, it is considered that the SRC UE does not know the link budget to the DST UE, this is particularly noted in a shared spectrum environment where interference levels vary in time. As such, always using max power and maximum coding, will result in poor spectral efficiency and poor UE power consumption. According to embodiments, in this situation adaptive MCS (modulation and coding) and HARQ can be used.

However, if the SRC UE changes the MCS, the DST UE will have to blind decode all possible MCS which leads to high UE complexity. As such, according to embodiments, there is provided a fixed MCS/TBS. The SL data and control channels are transmitted without preceding grants using a fixed transport block (TB) size and a small set of MCS to limit blind decoding. The MCS set can be pre-defined or stored in the SL server. When the SL connected mode is established, the SRC UE transmits data directly on the SL-PO(s) of the DST, and the DST responds with an ACK. The radio link control (RLC) header sequence number may be used by the DST UE to distinguish between transmissions and retransmissions.

According to embodiments, there is provided a grant-based HARQ. In this scenario, the SRC UE first sends a grant in the control channel indicating information (e.g. modulation, size, coding, re-transmission flag) about the SL data to be transmitted. The number of information bits in the grant is fixed and a small set of MCS is used to encode the grant to limit blind decoding of the grant. The SRC UE selects an MCS based on one or more of: (i) the channel quality indication (CQI) received from the DST UE that estimates the channel quality from e.g. the demodulation reference signal (DMRS) of previously received SL messages and (ii) estimates the channel quality based on e.g. the DMRS received from the DST UE in previous ACKs. This option assumes channel reciprocity. According to embodiments, before receiving CQI or DMRS from DST, the SRC UE uses the most conservative MCS scheme.

According to embodiments, the timing relationship between the grants, ACKs and SL data depends on the SL HARQ frame length. The SL HARQ frame length defines when the SRC UE and DST UE switch from receiving to transmitting SL. To reduce UE decoding complexity, the following rules apply regardless of the SL HARQ frame length: (i) the SL grant is sent at least X′ TTIs before the SL data transmission and (ii) the ACK is sent at least Y′ TTIs after the SL data transmission.

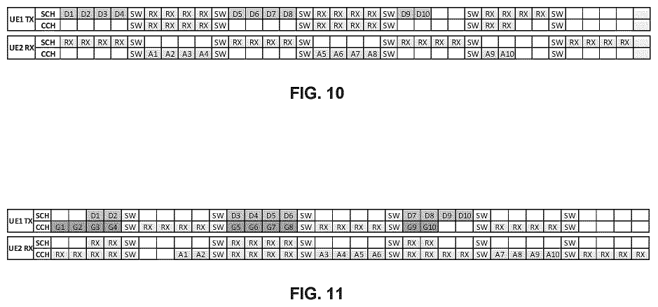

For example, for X′=2, and Y′=4, if HARQ frame length is 10, the UEs will receive for 4 TTIs, switch to transmission mode, transmit for 4 TTI, switch to reception mode and repeat. In this case, the following timing occurs (with the assumption that 1 SF is allotted for switching between transmission and reception modes). If the SL grant is sent in the 1^{st} or 2^{nd} TTI in the frame, the SL grant is sent 2 TTIs before the SL data transmission. If the SL grant is sent in the 3^{rd} or 4^{th} TTI in the frame, the SL grant is sent 8 TTIs before the SL data transmission. If decoded correctly, the ACK is at least 4 TTIs from SL data transmission, otherwise nothing is sent. FIG. 10 shows the timing diagram for the case of X′=2, and Y′=4 and a SL-U HARQ frame length of 10, for the grant-free mode. FIG. 11 shows the timing diagram for the case of X′=2, and Y′=4 and a SL-U HARQ frame length of 10, for the grant-based HARQ mode. This operation assumes that the switching is allotted 1 SF. It would be readily understood that the SL-U HARQ may be a SL-HARQ or a D2D HARQ depending on the format or band being used for the communications.

According to embodiments, this configuration allows the UEs in SL connected mode to support interactive bidirectional communication by transmitting SL data in the shared channel (SCH) multiplexed together in the same TTI with ACK and grants in the control channel (CCH). The SCH and CCH channels can be frequency division multiple access (FDMA). For example, 3 physical resource blocks (PRBs) can be used for the CCH and 3 different PRBs for the SCH. The FDMA structure can be specified or indicated by the SL Server.

It is considered that if the DST UE is active on the CC during its SL-PO(s), the DST UE will not be able decode the SL-PO(s), which can double the control plane latency. For DST UEs which are frequently active on the CC, this can occur often and therefore, it can be considered that there is no upper bound to the control plane latency (i.e. latency can be >2X SL-PO interval). As for configuration purposes, there can be a need to configure this SL-U communication for a near worst case latency (i.e. the 99% case), this may render SL-U an infeasible solution. It will be readily understood that the above could equally be applied to SL or D2D communications.

According to embodiments, an SL availability message (SAM) is introduced to let the SRC know when the DST UE is unavailable for SL-U and when it is dynamically available for SL-U. In particular, SAM communicates one of: (i) unavailable SL-PO(s) SAM (SAM-U), wherein the SAM-U can be transmitted when DST UE is likely unavailable to decode any upcoming SL-PO(s). For example, this would be sent by DST UE when it is in ConA mode and (ii) dynamic SL-POs SAM (SAM-D), wherein the SAM-D can be transmitted when DST UE is available to decode SL for the next T TTIs (for example, creates dynamic SL-PO(s)). The value of T can be fixed or UE specific from SL server or optionally communicated within the SAM. It can be considered that the absence of a SAM inherently indicates to the SRC UE that the DST UE will decode its SL-PO(s). It will be readily understood that the above could equally be applied to SL or D2D communications.

According to embodiments, the duration of SAM can fit within the minimum available SL transmission opportunity (for example, for LTE-M, this is a switch SF of 1 ms) including the time it takes to switch from CC to SL and SL to CC. In may be considered that the minimum information within the SAM is the SL UE ID (for example which can be unique within the local area SL is used), unavailability for SL (SAM-U) and availability of SL (SAM-D), and optionally the value of T. SAM maybe be configured as a channel with a defined modulation and coding or SAM may be configured as a signal. If SAM is configured as a signal, collision control can be built into the SAM signal configuration by using sequences with desired levels of cross correlation patterns for example, Zadoff-Chu codes or Gold codes. Furthermore, SAM transmission can be frequency division multiplexed over the CCH and SCH.

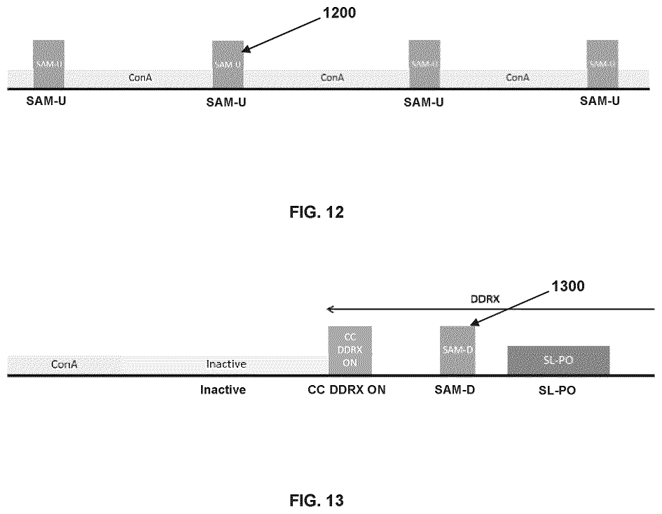

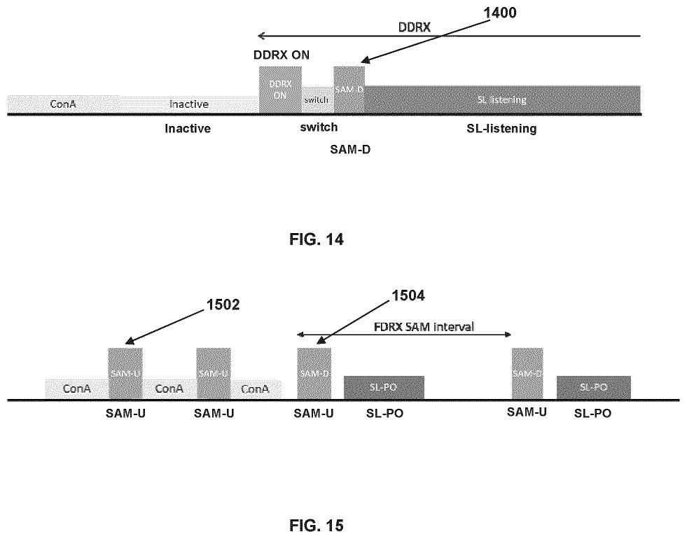

FIG. 12 illustrates an example where the UE is in ConA mode and sends a SAM-U 1200 in any available TTI, for example within the switch SFs. FIG. 13 illustrates an example where the UE is in CC DDRX mode, the UE sends a Dynamic SL-PO SAM (SAM-D) 1300 during the DDRX OFF duration to indicate upcoming dynamic SL-POs and where T=10 TTIs. FIG. 14 illustrates an example where the UE is in CC DDRX mode and the UE sends a Dynamic SL-PO SAM (SAM-D) 1400 during the DDRX OFF duration to indicate upcoming dynamic SL-POs where T=entire CDRX off period. If the DST UE is in SL LLM, T can be considered to be the entire DDRX OFF period. FIG. 15 illustrates an example where the UE sends SAM-U 1502 when in ConA mode, and subsequently sends two SAM-D 1504 when it enters CC FDRX.

According to embodiments, one or more SAM-Ds may be sent to improve reachability. The sending of multiple SAM-Ds can be even more useful if the CC doesn't support a DDRX mode. For example, when release assistance indication (RAI) is enabled in LTE-M, the UE skips the CDRX mode and enters IDRX immediately following the end of the connected active duration.

According to embodiments, several options for the SRC UE SAM procedure are described below. It can be left up to the SRC UE to choose the most suitable procedure based on power, latency, the typical traffic condition, SAM period and SL-DRX period or can be predefined or obtained from the SL Server. The SAM period can be considered to be the minimum period in which the DST UE will send SAM-Us when SL is unavailable.

According to embodiments a SRC UE SAM procedure can be defined as follows. Step 1 includes listening after request (LAR) mode, which can be broken down into the following sub-steps. Step 1(a) after receiving a SL-U Tx request, the SRC UE listens for SAM for at least the SAM Period. Step 1(b) If the SRC UE receives a SAM-U from the DST UE, the SRC UE goes to sleep for a SAM Sleep Period (SSP). The SSP can be chosen based on system parameters and system behavior such as SAM Period, DRX IT, DDRX cycle, and IDRX SAM Interval and a trade-off between latency and battery life. For example, for LTE-M, SSP can be equal to the DRX Inactivity Time, since the SRC UE knows that the DST UE in ConA mode takes at least DRX Inactivity Time to enter a CDRX mode. After sleeping for SSP, the SRC UE wakes up and subsequently performs Step 1(a). Step 1(c) Else If the SRC UE receives a SAM-D from the DST, SRC UE transmits the SL data during the dynamic SL-PO. If the UE does not receive an ACK for the transmitted data, the UE subsequently performs Step 1(a). Step 1(d) Else If the UE receives no SAMs, the SRC UE waits for the SL-PO then transmits data in the SL-PO. If the UE does not receive an ACK for the transmitted data, the UE subsequently performs Step 1(a).

According to embodiments, Step 2 includes listening before PO (LBP) mode which includes the following sub-steps. Step 2(a) after receiving an SL-U Tx request, the SRC UE listens for a SAM for SAM period immediately preceding the DST UE's SL-POs. Step 2(b) is to subsequently perform Step 1(b).

According to embodiments, Step 3 includes listening after transmitting SL (LAT) mode which includes the following sub-steps. Step 3(a) After receiving an SL-U Tx request, the SRC UE waits for the SL-PO then transmits data in the SL-PO. If the UE does not receive ACK, it starts listening for the SAM period for a SAM. Step 3(b) is to subsequently perform Step 1(b). It would be readily understood that for the above discussed SRC UE SAM procedure the SL-U Tx request may be a SL-Tx request or a D2D Tx request depending on the format or band being used for the communications.

According to some embodiments, a SAM period is typically between 10 ms-1000 ms which is either system wide or UE specific stored in the SL Server. The SAM period can be either pre-configured or obtained from the SL server. The SAM period can be set large enough to allow the DST UE to send at least one SAM within this period. For example, for LTE-M if G=1 and Multi-RAT coexistence is not supported, the SAM period must be longer than the sum of DRX inactivity timer and the CDRX ON duration. It would be readily understood that for the above discussed SL server may be defined as a SL-U server or a D2D server depending on the format or band being used for the communications.

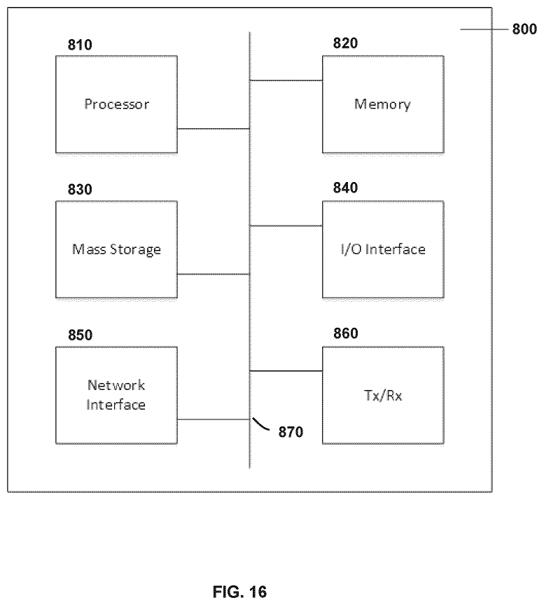

FIG. 16 is a schematic diagram of an electronic device 800 that may perform any or all of the steps of the above methods and features described herein, according to different embodiments of the present invention. For example, a UE may be configured as the electronic device.

As shown, the device includes a processor 810, memory 820, non-transitory mass storage 830, I/O interface 840, network interface 850, and a transceiver 860, all of which are communicatively coupled via bi-directional bus 870. According to certain embodiments, any or all of the depicted elements may be utilized, or only a subset of the elements. Further, the device 800 may contain multiple instances of certain elements, such as multiple processors, memories, or transceivers. Also, elements of the hardware device may be directly coupled to other elements without the bi-directional bus.

The memory 820 may include any type of non-transitory memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method steps described above.

As previously discussed, it will be readily understood that communication between wireless devices can be enabled in multiple ways, and it can be defined as device to device (D2D) communications. In some embodiments of the present disclosure D2D communication has been defined as side link (SL) communications as an example. However, it will be readily understood by a worker skilled in the art how to apply any embodiments which may be defined as SL communications to a more general version of D2D communications. Also as previously discussed, it will be further understood that while some of the discussion above relates to D2D communications, for example SL communications, using unlicensed bands, it would be readily understood how to apply such embodiments when using licensed bands as well.

As will be readily understood by the description above, the terms base station and network node can be interchangeably used to define an evolved NodeB (eNB), a next generation NodeB (gNB) or other base station or network node configuration.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1-20. (canceled)

21. A method for sidelink (SL) communication, the method comprising:
identifying, by a destination user equipment (UE), a time opportunity for the SL communication; and
upon determination of a need for the SL communication by a source UE, activating, by the source UE, SL communication during the time opportunity;
wherein the destination UE listens for SL communications at least during the time opportunity;
a SL discontinuous reception (SL--DRX) period is chosen by one or more of the destination UE and the source UE;
the time opportunity occurs at least once every SL-DRX period and the destination UE sleeps for a time period at least once every SL-DRX period; and
the time opportunity does not overlap with at least one of a plurality of cellular communication modes.

22. The method according to claim 21, wherein the time opportunity is equivalent to one or more time slots.

23. The method according to claim 21, wherein the time opportunity and at least one of the plurality of cellular communication modes are separated by an offset.

24. The method according to claim 21, further comprising:
releasing, by the destination UE, an SL connection in the absence of the SL communication from the source UE until expiry of an inactivity timer,

25. The method of claim 21, wherein the plurality of cellular communication modes includes one or more of a connected active mode, a connected DRX mode and an idle DRX mode.

26. The method according to claim 21, wherein the SL-DRX period is registered with a central server.

27. The method according to claim 21, wherein the time opportunity is dependent on an identifier of the destination UE.

28. The method according to claim 23, wherein the offset is provided by a central server.

29. The method according to claim 21, wherein when the source UE and the destination UE are within cellular coverage associated with a cellular network, the source UE and the destination UE synchronize using the cellular network.

30. The method according to claim 21, wherein the SL communication uses radio hardware associated with a cellular communication.

31. The method according to claim 21, further comprising:
transmitting, by one or more of the source UE and the destination UE, a sidelink availability message.

32. A destination user equipment (UE) comprising:
a processor; and
a non-transient memory for storing instructions that when executed by the processor cause the destination UE to be configured to:
identify a time opportunity for sidelink (SL) communication, wherein the destination UE listens for SL communication at least during the time opportunity, wherein a SL discontinuous reception (SL-DRX) period is chosen by one or more of the destination UE or a source UE, the time opportunity occurs at least once every SL-DRX period, the destination UE sleeps for a time period at least once every SL-DRX period, the time opportunity does not overlap with at least one of a plurality of cellular communication modes; and
upon determination of a need for the sidelink communication by the source UE, activating by the source UE the sidelink communication during the time opportunity.

33. The destination UE according to claim 32, wherein the time opportunity is equivalent to one or more time slots.

34. The destination UE according to claim 32, wherein the time opportunity and at least one of the plurality of cellular communication modes are separated by an offset.

35. The destination UE according to claim 32, wherein the instructions when executed by the processor further cause the destination UE to be configured to:
release the SL connection in the absence of the SL communication from the source UE until the expiry of an inactivity timer.

36. The destination UE of claim 32, wherein the plurality of cellular communication modes includes one or more of a connected active mode, a connected DRX mode, and an idle DRX mode.
